(19) United States
(12) Patent Application Publication
(10) Pub. No.: US 2019/0359916 A1
(43) Pub. Date: Nov. 28, 2019

(54) BAR SOAP FORMING ASSEMBLY AND METHOD OF FORMING SHAPED SOAP BARS FROM SOAP SLABS

(71) Applicant: Donald Neal Frykman, Grants Pass, OR (US)

(72) Inventor: Donald Neal Frykman, Grants Pass, OR (US)

(21) Appl. No.: 16/194,329

(22) Filed: Nov. 17, 2018

Related U.S. Application Data
(60) Provisional application No. 62/674,919, filed on May 22, 2018.

(51) Int. Cl. C11D 13/18; C11D 13/16

(52) U.S. Cl. CPC C11D 13/18; B30B 9/04; C11D 13/16

(57) ABSTRACT

A soap bar forming apparatus and method for forming a soap bar by compression welding a plurality of soap slabs is configured to mechanically weld a plurality of soap slabs into a single soap bar of a usable size. The soap slabs are placed on the open top chamber of the lower casing in a flat stacked position. The upper casing is then placed over the lower casing and then both the casings are tied in place by the Velcro® straps. The upper casing detachably couples to the lower casing and a pair of detachable straps fasten the casings together. A drive member presses the soap slabs together, and comprises a rotatable compression screw terminating at a compression plate, and an “E”-Ring that fastens the compression screw and compression plate together, and allows the compression screw to rotate while the compression plate moves up and down without twisting. The rotatable compression screw rotatably passes through the threaded drive hole in the upper casing, forcibly urging the compression plate onto the soap slabs to compress the soap slabs into a single large soap bar.

### CROSS-REFERENCE TO RELATED APPLICATIONS

This application claims priority from U.S. Provisional Application Ser. No. 62/674,919, entitled “Bar Soap Forming Assembly and Method of Forming Shaped Soap Bars from Slabs”, filed on May 22, 2018, which application is hereby incorporated herein by reference in its entirety.

### FIELD OF THE INVENTION

The present invention relates generally to an apparatus and method for uniting soap slabs into a unified soap bar. More particularly, the present invention relates to an apparatus and method for forming a soap bar by compression welding a plurality of soap slabs.

### BACKGROUND OF THE INVENTION

Those skilled in the art will recognize that soap bars can be scarce or expensive for some people, further some luxury soaps are very expensive. Some people find it desirable to try to make use of worn pieces of soap to the fullest to meet their needs and to not waste small pieces of the soap. Often, people throw away small pieces of bar soap, as it is difficult to hold and use a piece of soap after it reaches a small size. Thus, small pieces of soap are often discarded, which is wasteful and expensive.

In today's society, luxury soaps can often be very expensive and wasting small pieces of luxury soap is also not desirable. Thus, it is desirable to provide a device that saves or recycles small pieces of soap or small soap slabs into a usable size of soap bar.

Numerous attempts have been made and several prior art devices are known for uniting soap slabs into a unified soap bar. Even though these innovations may be suitable for the specific purposes to which they address, however, they would not be as suitable for the purposes of the present invention.

For example, U.S. Pat. No. 504,206 to Eckman discloses an automatic machine which provides a mechanism adapted to feed a continuous stream of soap cakes into one side of the machine, compressing the cakes between dies so as to give them the necessary shape and eject the shaped cakes from the other side of the machine.

U.S. Pat. No. 525,391 to Palmer teaches a soap press having a plurality of movable die cases, a vertically movable die plate in each case, a reciprocating die, and means for moving the die cases beneath the same, and by a further movement automatically expelling the cake of soap from the die case.

U.S. Pat. No. 604,436 to Swartz describes a domestic soap press, comprising the pivoted handles, a cup shaped disk fixed to the handle, and provided with a series of guide-ears, and an intervening series of recesses and the oppositely-disposed cup-shaped disk formed with a series of guide-ears and intervening recesses alternating with the corresponding guide-ears and recesses on the disk. Small scraps of soap which are too small to be conveniently used separately are collected together and placed in the mold or press and the handles brought together. The intermeshing of the guide-ears and intervening recesses allows the disks to approach nearer together, thereby closing the recesses, while the projecting ends of the teeth prevent the escape of the material through the recesses. The resulting cake is of a double-convex form.

U.S. Pat. No. 647,822 to Forrester discloses a soap-pressing machine comprising a framework, a soap-cake mold, an endless carrier for feeding and delivering the cakes of soap, spring-dogs for laterally feeding the cakes of soap into the mold, plungers provided with soap dies, and levers for operating said plungers for compressing the soap, and a means for conveying the soap to the wrapping-table after being discharged from the mold.

U.S. Pat. No. 1,770,646 to Hennequin describes a press for molding soap and plastic materials and/or impressing the makers name or trade-mark on other matter thereon. The press comprises a ram or plunger operated from a fly-wheel mounted upon a floating spindle. Such presses are operated by hand. The operator turns a handle, thereby turning the fly-wheel to depress the ram or plunger so as to press the cake of soap or the like between suitable dies or molds.

U.S. Pat. No. 4,781,564 to Cerrone teaches a soap press component and a grinding component, operatively associated with one another. The grinding component has an inlet for receiving small soap bars or end pieces, and means for grinding them to even finer pieces or shavings. The soap press component has a chamber having an open top, bottom ends and a mold plate within the chamber. Whereby applying pressure on such soap shavings, presses them into a single bar shaped soap resembling the shape of the chamber. The shaped bar is removed from the chamber bottom end.

U.S. Pat. No. 5,375,778 to Lundquist discloses a process for removing contamination from plastic material, such as plastic containers, and plastic scrap prior to further processing into a finished plastic pellet.

U.S. Pat. No. 6,106,270 to Hardin describes a waste soap compressor comprising a movable compressor plate mounted within a container. An extension member is coupled to the compression plate and is forcibly moved along with the compression plate by a drive member using an electrical motor or hydraulic pressure to forcibly urge the compression plate into a plurality of small bars of soap to compress the small bars of soap into a single large bar of soap.

U.S. Pat. No. 8,529,239 to Black, Jr. teaches a soap remnant molding assembly for combining, heating and re-forming small soap remnants into full size soap bars. The assembly includes a housing, a tray positioned in the housing, a plurality of heating elements around the tray. Applying heat and then cooling the tray such that the soap remnants convert to a liquid and the liquid in the tray subsequently hardens into a single soap bar.

U.S. Pat. No. 9,765,290 to Welcome discloses an apparatus and method for melting soap fragments to create a soap bar from the soap fragments. The apparatus includes various replaceable molds to create soap bars having various shapes.

It is apparent now that numerous innovations that are adapted to an apparatus for uniting soap slabs into a unified soap bar have been developed in the prior art that are adequate for various purposes. Furthermore, even though these innovations may be suitable for the specific purposes to which they address, accordingly, they would not be suitable for the purposes of the present invention as heretofore described. Thus an apparatus and method for forming a soap bar by compression welding a plurality of soap slabs is needed.

### SUMMARY OF THE INVENTION

The present invention relates to an apparatus and method for forming a soap bar by compression welding a plurality of soap slabs. The apparatus typically uses multiple small soap slabs and worn soap pieces, to form a single soap bar of a usable size and specific shape through use of a lower casing that retains a plurality of soap slabs, an upper casing that forms a threaded drive hole and detachably couples to the lower casing, a pair of detachable straps that fasten the casings together, a drive member comprising a rotatable compression screw terminating at a compression plate, and an “E”-Ring disposed at the junction of the compression screw and the compression plate to fasten the compression screw and compression plate together, and to allow the compression screw to rotate while the compression plate moves up and down; whereby the rotatable compression screw rotatably passes through the threaded drive hole in the upper casing to forcibly urge the compression plate, so as to compression weld the soap into a single new soap bar.

According to an aspect of the present invention, an apparatus and method for forming a soap bar by compression welding a plurality of soap slabs, the apparatus comprising a lower casing having an open top chamber enclosed by one or more side walls and a bottom wall; an upper casing having an open bottom chamber enclosed by one or more side walls and a top wall, wherein the open bottom chamber is configured to enclose the lower casing, the top wall further defined by a neck, the neck forming a concentric threaded drive hole; a plurality of straps detachably retaining the upper and lower casings together; a drive member configured to forcibly press a slab of soap bars together onto a single soap bar, the drive member comprising a rotatable compression screw and a compression plate, the compression plate having an upper end forming a slot and a lower end engaging the soap slab, the compression plate forming a threaded cavity adapted to receive the rotatable compression screw; and an “E”-Ring fitted into at least one slot in the upper end of the compression plate, approximately at the junction between the compression screw and the compression plate, thereby the “E”-Ring fastening the rotatable compression screw to the compression plate, whereby the “E”-Ring enables the compression screw to rotate while the compression plate moves up and down without twisting, whereby hand rotating the compression screw forcibly urge the compression plate onto the soap slab, so as to compress the soap slabs into a single large soap bar, whereby the straps maintain the casings in a stable, joined configuration while the soap slabs are pressed against the casings.

In view of the foregoing, it is therefore an objective of the present invention to mechanically weld worn or small soap bars to a single soap bar of a usable size and shape.

Another objective is to minimize waste of used and worn pieces of soap.

Yet another objective is to weld a soap slab to a whole soap bar, so as to create a new soap bar.

Yet another objective is to securely hold the upper and lower casings together with Velcro® straps.

Yet another objective is to facilitate separation of the casings through detachment of the straps.

Yet another objective is to fabricate the soap bar forming apparatus from rust resistant and light weight material.

Yet another objective is to provide an inexpensive to manufacture a soap bar forming apparatus.

Other objectives and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The invention will now be described, by way of example, with reference to the accompanying drawings, in which:

FIG. 1 illustrates a front view of an exemplary bar soap forming apparatus, in accordance with an embodiment of the present invention;

FIG. 2 illustrates a sectioned front view of the soap bar forming apparatus shown in FIG. 1, showing the compression plate positioned to press against soap slabs, in accordance with an embodiment of the present invention;

FIG. 3 illustrates a sectioned front view of the soap bar forming apparatus shown in FIG. 1, showing the compression plate pressing the soap slabs into a single soap bar, in accordance with an embodiment of the present invention;

FIG. 4 illustrates a top view of the soap bar forming apparatus showing a pair of Velcro® straps wrapped around the casings, in accordance with an embodiment of the present invention;

FIG. 5 illustrates a front view of the soap bar forming apparatus shown in FIG. 1, in accordance with an embodiment of the present invention;

FIG. 6 illustrates a bottom view of the soap bar forming apparatus, showing a first Velcro® strap wrapped around the casings, and a second Velcro® strap unwrapped, in accordance with an embodiment of the present invention;

FIGS. 7A and 7B illustrates a sectioned front view of the soap bar forming apparatus shown, where FIG. 7A shows the drive member, and FIG. 7B shows a close up of the compression plate and terminus of the rotatable compression screw, in accordance with an embodiment of the present invention;

FIG. 8 illustrates a sectioned front view of the soap bar forming apparatus, showing the “E”-Ring being fitted into the slots that form at the upper end of the compression plate, in accordance with an embodiment of the present invention;

FIGS. 9A-9B illustrate perspective views of the formation of a compression welded soap bar from smaller soap slabs, where FIG. 9A shows three soap slabs stacked one over the other for pressing, FIG. 9B shows the formed compression welded soap bar, in accordance with an embodiment of the present invention; and

FIG. 10 references a flowchart of an exemplary method of forming a soap bar by compression welding a plurality of soap slabs, in accordance with an embodiment of the present invention.

Like reference numerals refer to like parts throughout the various views of the drawings.

### DETAILED DESCRIPTION OF THE INVENTION

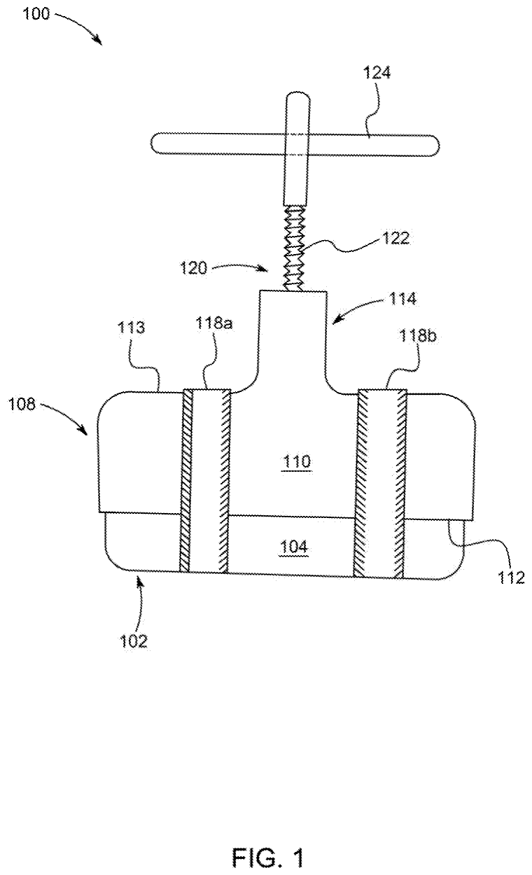

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A soap bar forming assembly, also herein after referred as an apparatus 100 and a method 200 for forming desired shaped soap bars from a plurality of soap slabs are referenced in FIGS. 1-10. The apparatus 100 is configured to mechanically compress soap slabs 300a to be compression welded into a single soap bar 302 of a usable size. A pair of straps 118a, 118b fastens the upper casing 108 and lower casing 102 together during the soap bar formation process.

A drive member 120 comprising a rotatable compression screw 122 having a first end 123 and a second end 136 and a compression plate 126 having an upper end 128 and a lower end 132, wherein the compression screw 122 rotatably passes a compression plate 126 through the upper casing 108 to press the soap slabs 300a together against the lower casing 102. The upper casing 108 should fit loosely enough, so that it does not stick to the lower casing 102 when the compression plate 126 is turned upward, thereby releasing the pressure from the compression plate 126, allowing the casings 102, 108 to be opened by releasing the Velcro® strips 118a, 118b. The upper casing 108 creates an overlap with the lower casing 102. An “E”-Ring 138 fastens the compression screw 122 and compression plate 126 together, and allows the compression screw 122 to rotate while the compression plate 126 moves up and down to weld soap pieces 300a.

According to one aspect of the present invention, an apparatus 100 for forming a soap bar 302 by compression welding a plurality of soap slabs 300a, the apparatus 100 comprising a lower casing 102 having an open top chamber 106; an upper casing 108 having an open bottom chamber 112 that is configured to enclose the lower casing 102, wherein the upper casing 108 further comprising a top wall 113 defined by a neck 114, whereby the neck 114 forming a concentric threaded drive hole 116; a rotatable compression screw 122 having a first end 123 and a second end 136; a compression plate 126 having an upper end 128 and a lower end 132, whereby the upper end 128 comprising at least one cut slot 130; whereby the second end 136 of the rotatable compression screw 122 passes through the threaded drive hole 116 of the upper casing 108 and into a cavity 134 of the upper end 128 of the compression plate 126, whereby, the lower end 132 of the compression plate 126 is flat and is configured to engage with the soap slabs 300a placed in the open top chamber 106 of the lower casing 102, wherein the soap slabs 300a are soaked in hot water for a predetermined time to form a film over surface of each of the soap slabs 300a; an “E”-Ring 138, wherein the at least one slot 130 in the upper end 128 of the compression plate 126 is configured to allow the “E”-Ring 138 to engage with the unthreaded part of the compression screw 122 which has a 360 degree slot cut 130 around it. This slot is in position with another two slots (not shown) allowing the “E” ring 138 to snap-lock upper casing 108 and lower casing 102 together with compression screw 122, thereby allowing the compression plate 126 to move up and down without twisting it while rotating the compression screw 122, and a means 118a-b for detachably retaining the upper and the lower casings 108, 102 together, while force is applied on the plurality of soap slabs 300a in the lower casing 102 through the lower end 132 of the compression plate 126 to compress the soaked soap slabs 300a to weld with each other to form the soap bar 302.

In another aspect, the upper end 128 of the compression plate 126 comprises a tubular profile that is configured to mate with the profile of the neck 114 of the upper casing 108 when the compression plate 126 is moved upward.

In another aspect, a handle 124 is attached to a first end 123 of the compression screw 122 to facilitate the rotation of the compression screw 122 to move the compression plate 126 up and down without twisting the compression plate.

In another aspect, the means 118a-b for detachably retaining the upper and the lower casings 108, 102 together is a pair of Velcro® straps.

According to another aspect of the present invention, an apparatus 100 for forming a soap bar 302 by compression welding a plurality of soap slabs 300a, the apparatus 100 comprising a lower casing 102 having an open top chamber 106 enclosed by one or more side walls 104 and a bottom wall 105; an upper casing 108 having an open bottom chamber 112 enclosed by one or more side walls 110 and a top wall 113, wherein the open bottom chamber 112 is configured to enclose the lower casing 102, the top wall 113 of the upper casing 108 is further defined by a neck 114, the neck 114 forming a concentric threaded drive hole 116; a drive member 120, wherein the drive member 120 comprises a rotatable compression screw 122 having a first end 123 and a second end 136 and a compression plate 126 having an upper end 128 and a lower end 132, whereby the upper end 128 of the compression plate 126 comprises a tubular profile that is configured to mate with the profile of the neck 114 of the upper casing 108 when the drive member 120 is moved upward and further the upper end 128 of the compression plate 126 comprises a 360 degree cut slot 130, whereby a handle 124 is attached to the first end 123 of the compression screw 122 and the second end 136 of the compression screw 122 passes through the threaded drive hole 116 in the neck 114 of the upper casing 108 and into a threaded cavity 134 of the upper end 128 of the compression plate 126, whereby, the lower end 132 of the compression plate 126 is flat and is configured to engage with the soap slabs 300a placed in the open top chamber 106 of the lower casing 102, wherein the soap slabs 300a are soaked in hot water for a predetermined time to form a film over surface of each of the soap slabs 300a; an “E”-Ring 138, wherein the at least one slot 130 in the upper end 128 of the compression plate 126 is configured to allow the “E”-Ring 138 to engage with the compression screw 122, thereby allowing the compression plate 126 to move up and down without twisting it while rotating the handle 124 of the compression screw 122; and a plurality of straps 118a-b detachably retaining the upper and the lower casings 108, 102 together in a stable, joined configuration while force is applied on the plurality of soap slabs 300a in the lower casing 102 through the lower end 132 of the compression plate 126 of the drive member 120 to compress the soaked soap slabs 300a to weld with each other into a single soap bar 302.

In another aspect, the lower casing 102 and the upper casing 108 have a generally rectangular shape with rounded corners.

In another aspect, the straps 118a-b are fixedly fastened to the upper casing 108 thereby facilitating quick detachable attachment of the lower casing 102 to the upper casing 108.

In another aspect, the “E”-Ring 138 has a unique shape, thereby pressing the “E”-Ring 138 on to the compression screw 122 at the at least one slot 130 creates a snug fit of the “E”-Ring 138 with the compression screw 122.

In another aspect, the straps 118a, 118b comprises a pair of Velcro® straps 118a, 118b.

In another aspect, the lower casing 102 and the upper casing 108 are manufactured from material selected from the group consisting of polyurethane, polyethylene, polyvinyl chloride, a polymer and a metal or a combination thereof.

In another aspect, the soap slabs 300a are soaked in hot water for a predetermined time of ranging from about 3 to about 5 minutes to form a film over surface of each of the soap slabs 300a.

In another aspect, the soap slabs 300a are worn pieces of soap, or new soap having a smaller size than desired, or the like which are compression welded to form a soap bar 302 that is of desired size and shape.

As referenced in FIG. 1, the apparatus 100 contains a lower casing 102, an upper casing 108, a drive member 120 and a pair of straps 118a, 118b. The lower casing 102 retains the soap slabs 300a inside the lower casing 102 while the upper casing 108 detachably couples to the lower casing 102 in an overlapping manner. The pair of detachable straps 118a, 118b fastens the casings 108, 102 together in a stable, joined configuration while force is applied on the plurality of soap slabs 300a in the lower casing 102 through the drive member 120 to compress the soap slabs 300a to weld with each other into a single soap bar 302.

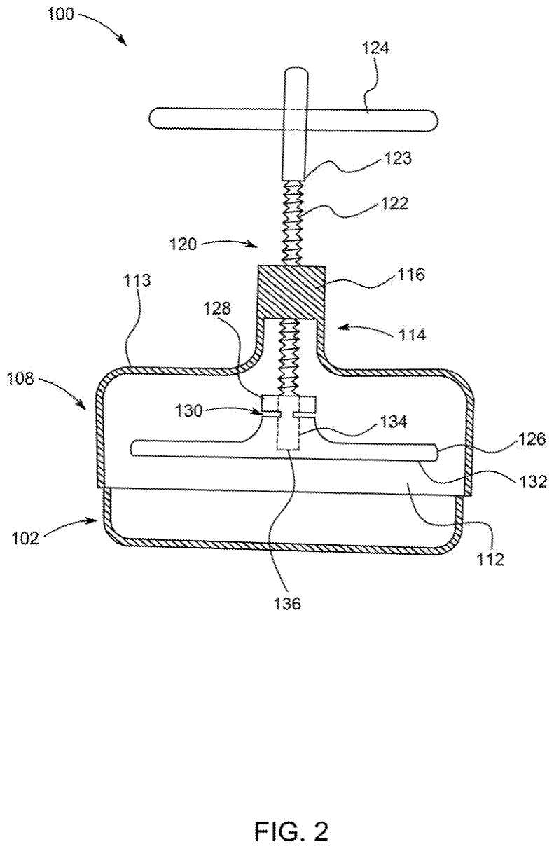

FIG. 2 illustrates a cross sectional view of the apparatus 100 showing the drive member 120 of the apparatus 100, the drive member 120 comprises a rotatable compression screw 122 having a first end 123 and a second end 136 and a compression plate 126 having an upper end 128 and a lower end 132. The upper end 128 of the compression plate 126 comprises a tubular profile that is configured to mate with the profile of the neck 114 of the upper casing 108 when the drive member 120 is moved upward. Further the upper end 128 of the compression plate 126 comprises at least one cut slot 130.A handle 124 is attached to the first end 123 of the compression screw 122 and the second end 136 of the compression screw 122 passes through the threaded drive hole 116 in the neck 114 of the upper casing 108 and into a cavity 134 of the upper end 128 of the compression plate 126.

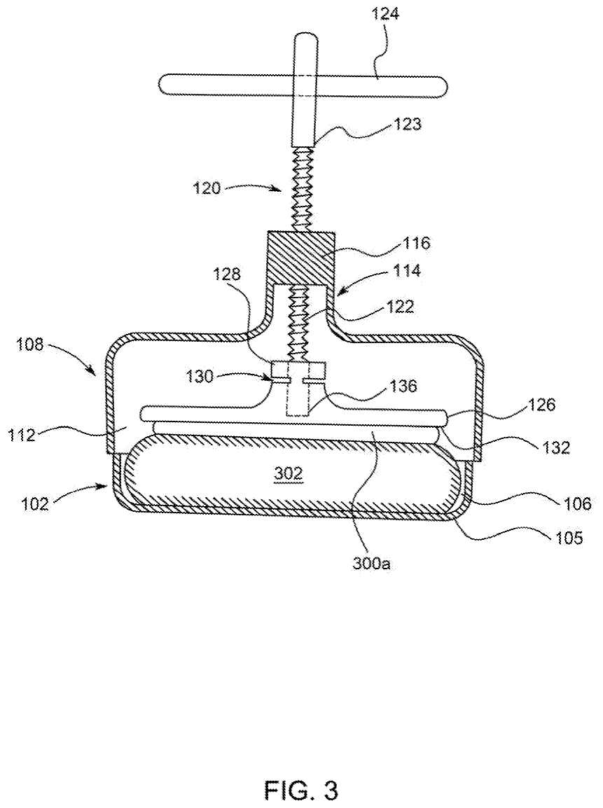

FIG. 3 illustrates cross section view of the apparatus 100 showing the lower casing 102 having an open top chamber 106 enclosed by one or more side walls 104 and a bottom wall 105. The open top chamber 106 is configured to contain the plurality of soap slabs 300a placed flat one over the other in in a vertically stacked position, wherein the soap slabs 300a are soaked in hot water for a predetermined time of about 3 to about 5 minutes to form a film over surface of each of the soap slabs 300a. Further the soap slabs 300a placed in the lower casing 102 are forcibly pressed into the finished shape of a single, usable soap bar 302 by compression welding the soap slabs 300a with each other by applying pressure through the lower flat end 132 of the compression plate 126 on the soap slabs 300a.

Similar to the lower casing 102, an oppositely disposed upper casing 108 is defined by a sidewall 110 having a predefined shape and a top wall 113 to form an open bottom chamber 112 of the upper casing 108. The open bottom chamber 112 of the upper casing 108 is configured to enclose the lower casing 102 containing the plurality of soap slabs 300a. Suitable materials for the casings 108, 102 may include, without limitation, polyurethane, polyethylene, polyvinyl chloride, a polymer and a metal or a combination thereof. However any light weight, corrosion resistant, and compression resistant material can be used without departing from the scope and spirit of the present invention.

As illustrated in FIG. 5, a plurality of straps 118a, 118b wrap around the upper and lower casings 108, 102 of the apparatus 100. In one non-limiting embodiment, the straps 118a-b comprises a pair of Velcro® strips. Though any resilient fastening means may be used to detachably fasten the upper and lower casings 108, 102 together. The Velcro® strips are long enough to be fastened together under the outside of the lower casing 102. This forcible restraining of casings 108, 102 resists pressure from the compression screw pressing against the soap slabs 300a in the lower casing 102. Thus, the straps 118a-b maintain the casings 108, 102 in a stable, joined configuration while the soap slabs are pressed.

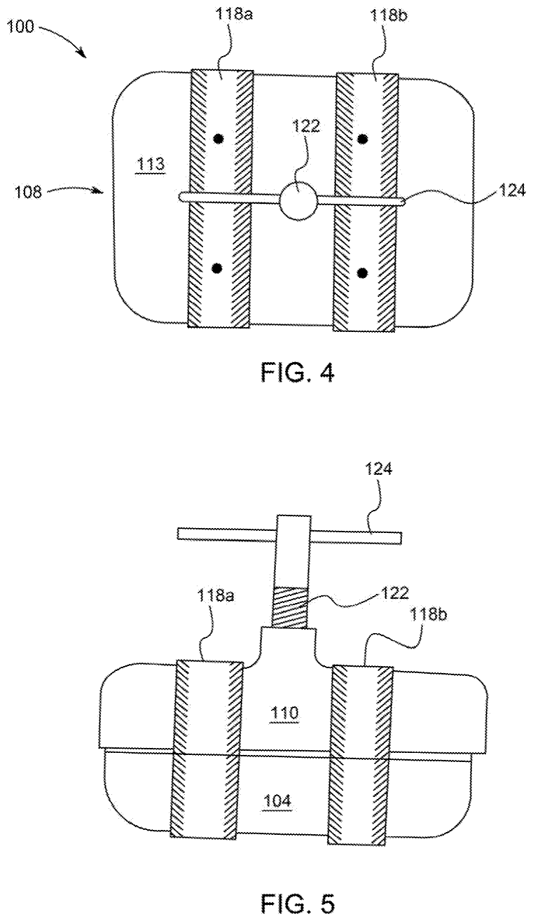

FIG. 4 shows a top view of the apparatus 100 illustrating the straps 118a-b being wrapped around the casings 102, 108. Further the straps 118a-b are fixed to the upper casing 108 by mounting one or more rivets or other known means to fixedly attach the straps 118a-b to the upper casing 108.

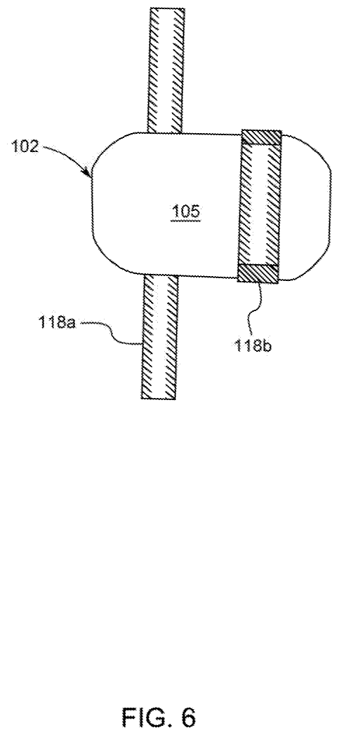

The straps 118a-b are configured to detachably fasten the upper and lower casings 108, 102 together. In some embodiments, the straps 118a, 118b may be fixedly fastened to the upper casing 108, and releasable from the lower casing 102 as shown in the bottom view of the apparatus 100 illustrated in FIG. 6. It shows a first strap 118a unwrapped, while a second strap 118b wraps around the casings 108, 102.

Looking back at FIG. 2, the apparatus 100 also comprises a drive member 120 configured to forcibly press the soap slabs 300a into the single soap bar 302 (FIG. 3). In some embodiments, the drive member 120 may include a rotatable compression screw 122 that is configured to raise and lower a compression plate 126 in relation to the soap slabs in the lower casing 102. The compression plate 126 is defined by an upper end 128 that rotatably joins with the compression screw 122. The “E”-Ring snaps into at least one slots 130 locking the pressure plate 126 to top assembly 100 for ease of assembly during construction, wherein the at least one slot 130 comprises a 360 degree slot cut 130 around the compression screw 122 and another two slots (not shown) on either opposite sides of the 360 degree slot cut 130 allowing the “E” ring 138 to snap-lock upper casing 108 and lower casing 102 together with compression screw 122 thereby allowing the compression plate 126 to move up and down without twisting it while rotating the compression screw 122.

As shown in FIGS. 1, 2, 3, 5, 7A, and 8, the top wall 113 of the upper casing 108 is defined by a neck 114 that extends from the upper surface of the sidewall 110. The neck 114 forms a threaded drive hole 116, through which a rotatable compression screw 122 operates, as described below. In one non-limiting embodiment, the neck 114 and threaded drive hole 116 are concentrically located in the upper casing 108. The neck 114 also serves to help guide the rotatable compression screw 122 into the chambers 106, 112 that form between the joined casings 102, 108.

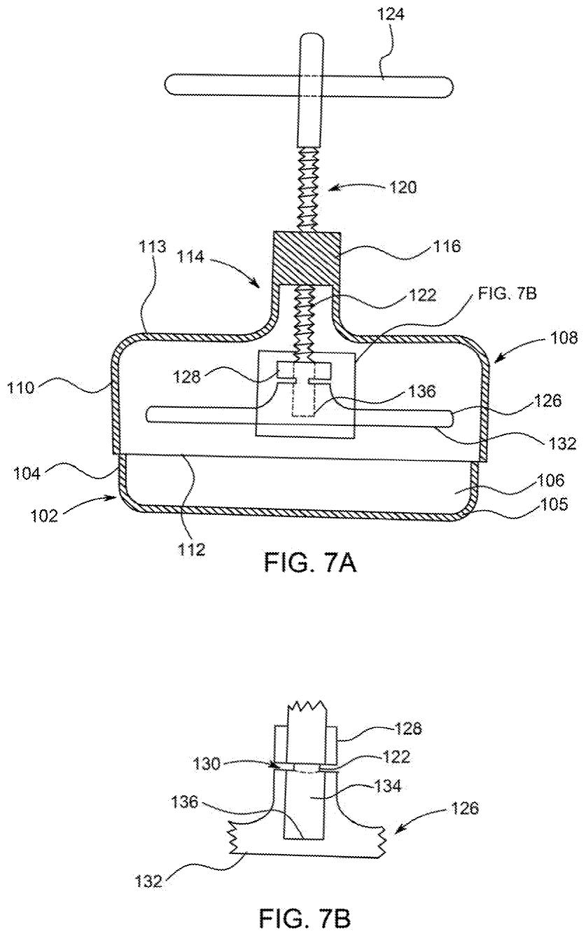

As shown in FIG. 7A, the compression plate 126 forms a cavity 134 adapted to receive the second end 136 of the compression screw 122. The rotatable compression screw 122 comprises a handle 124 that allows the compression screw 122 rotates in the first direction to lower the compression plate 126 onto the soap slabs, or the second direction to raise the plate from the formed soap bar 302. Thus, the rotatable compression screw 122 passes through the drive hole 116 in the neck 114 of the upper casing 108 and into the cavity 134 in the upper end 128 of the compression plate 126 to forcibly urge the compression plate 126 onto the soap slabs 300a. This pressurization on the soap slabs 300a, allows film over the soap slabs 300a to get compression welded with each other to form the soap bar 302.

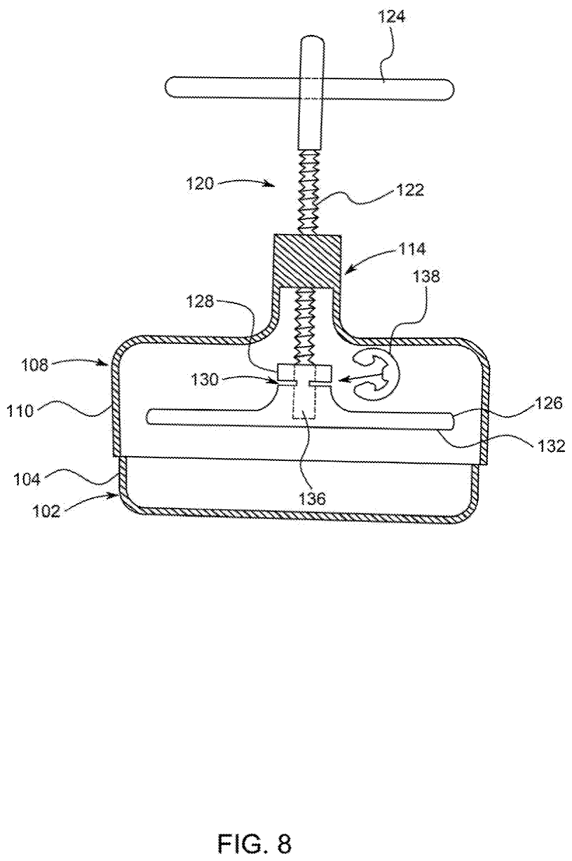

Looking now at FIG. 8, the apparatus 100 further comprises an “E”-Ring 138 that is fitted into the at least one slot 130 in the compression plate 126. The “E”-Ring 138 is disposed approximately at the junction between the compression screw 122 and the compression plate 126. The “E”-Ring 138 is configured to fasten the rotatable compression screw 122 to the compression plate 126. The compression plate 126 is further defined by a lower end 132 that is flat and solid for engaging the soap slabs and is configured to forcibly press the soap slabs 300a into a single soap bar 302 of a usable size.

FIG. 7B illustrates a close up view of the at least one slot 130 into which “E”-Ring 138 fits. In one embodiment, at least one slot 130 comprises a 360 degree slot cut 130 around the compression screw 122 and another two slots (not shown) on either opposite sides of the 360 degree slot cut 130. The at least one slot 130° around the neck of the upper end 128 of the compression plate 126 to allow the compression screw 122 to rotate completely around inside the “E”-Ring 138, which facilitates to raise and lower the compression plate 126 without twisting it. In operation of the drive member 120, the threaded compression screw 122 enters the drive hole 116 in the upper casing 108 and into the cavity 134 in the compression plate 126. The compression screw 122 is secured to the compression plate 126 by inserting the “E”-Ring 138 into the at least one slot 130.

The fit between the “E”-Ring 138 and the at least one slot 130 creates a snug fit that snap-fits the compression plate 126 against the second end 136 of the compression screw 122. Because of the unique shape and position of the “E”-Ring 138, the compression screw 122 rotates in the first direction to lower the compression plate 126 onto the soap slabs 300a, or the second direction to raise the plate 126 from the welded soap bar 302.

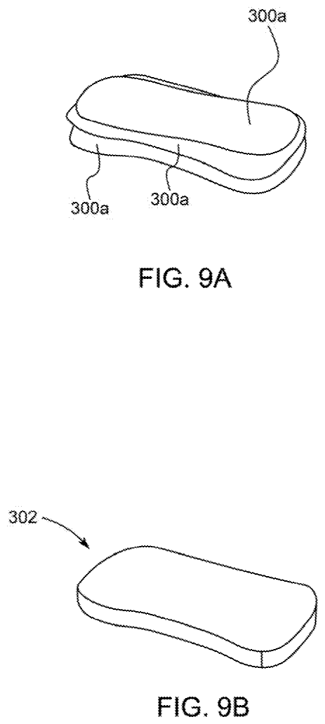

The lower end 132 of the compression plate 126 presses against the soap slabs 300a to weld them to form the soap bar 302. For example, FIGS. 9A-9B illustrate perspective views of the compression welded soap bars 302 from plurality of soap slabs 300a stacked flat one over the other and are being pressed together into gradual formation of the desired shaped soap bar 302 which are dried and available for use. One, two, or more soap slabs 300a are laid on top of each other at the same time in the open area 106 of the bottom of casing 102. The slabs 300a have all been soaked together in warm water at the same time and a welding film is developed on all surfaces of the slabs 300a, then the slabs 300a are stacked flat one over the other and then the slabs 300a are pressed together into one unit between the compression plate 126 and lower end 132 of the compression plate 126 forming pressure against the laid on slabs 300a as shown in FIG. 9A. The process is finished when the compression welded slabs 300a are allowed to dry. The welded soap slabs 300a are allowed to dry for use in only a few hours, preferably overnight to form a new soap bar 302 and can be used as such when properly dried as shown in FIG. 9B. FIG. 9A shows three pieces of soap slabs 300a pressed together to become compression welded with each other to fully form the soap bar 302 in the lower casing 102 of the apparatus 100 as shown in FIG. 9B. The formed soap bar 302 is dried and thus can be used as a single bar. This process may be accomplished by human hands without the need for electrical or mechanical assistance. Those skilled in the art will appreciate that electrical or mechanical means could also be employed.

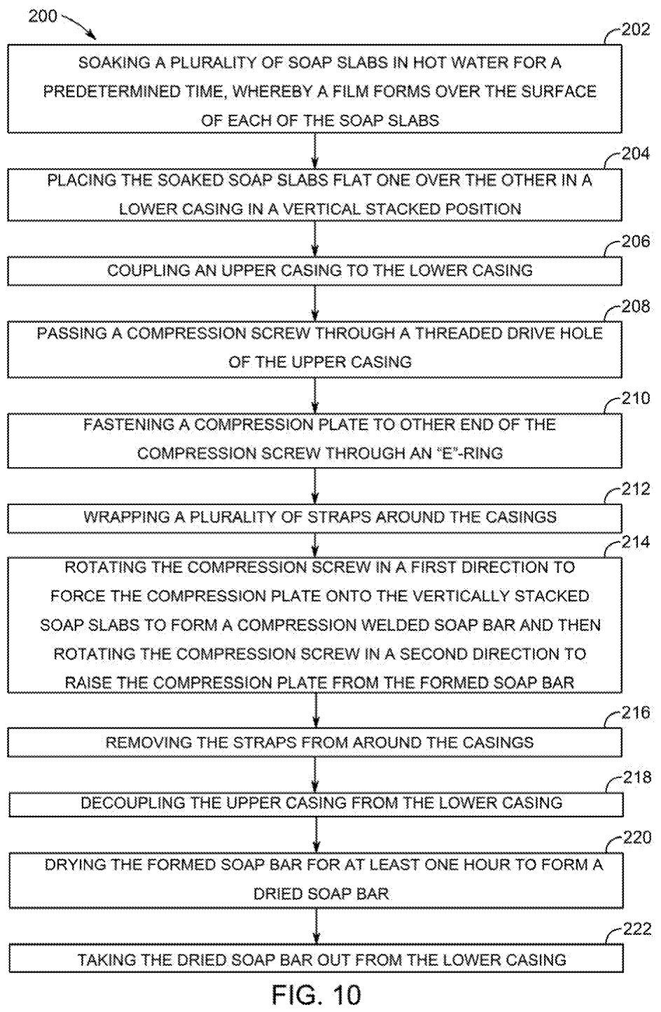

FIG. 10 references a method 200 for forming a soap bar from a plurality of soap slabs, wherein the soap bar is large enough to become usable for daily cleaning. The method 200 may include an initial Step 202 of soaking the plurality of soap slabs in hot water for a predetermined time of about 3 to about 5 minutes so as to form a film over surface of each of the soap slabs. This results in the soap acquiring a soft semi solid film which, when compressed by the compression plate 126, adheres the soap slabs with each other.

The method 200 may further comprise a Step 204 of placing the plurality of soap slabs flat one over the other in a lower casing in a stacked position. A Step 206 includes coupling an upper casing to the lower casing. In some embodiments, a Step 208 comprises passing a compression screw through a threaded drive hole of the upper casing, wherein a handle is attached to a first end of the compression screw. The straps may include Velcro® strips, which are long enough to be fastened together under the outside of the lower casing. This is necessary because turning the threaded compression screw down, to put pressure against the soap slabs laying in the lower casing, must have a means to resist the resulting pressure. A Step 210 includes fastening a compression plate to a second end of the compression screw through an “E”-Ring.

In some embodiments, a Step 212 may include wrapping a plurality of straps around the upper and lower casings. A Step 214 comprises rotating the handle to rotate the compression screw in a first direction to force the compression plate onto the vertically stacked soaked soap slabs to form a compression welded soap bar and then rotating the compression screw in a second direction to raise the compression plate from the formed soap bar without twisting the compression plate. In some embodiments, a Step 216 includes removing the straps from around the upper and the lower casings.

In other embodiments, a Step 218 comprises decoupling the upper casing from the lower casing. A Step 220 comprises drying the formed soap bar for at least one hour to form a dried soap bar. A final Step 222 comprises taking the dried soap bar out from the lower casing. The soap slabs will separate if not thoroughly dried. Allowing the soap bar to dry overnight allows the soap bar to take the shape of the casings and be as strong as a single new soap bar. The drying process can also be performed by leaving the soap bar in the lower casing of the apparatus, or carefully removing the welded soaps from the casing and allowing it to dry while using the apparatus for subsequent use.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An apparatus for forming a soap bar by compression welding a plurality of soap slabs, the apparatus comprising:
a lower casing having an open top chamber;
an upper casing having an open bottom chamber that is configured to enclose the lower casing, wherein the upper casing further comprises a top wall defined by a neck, whereby the neck forms a concentric threaded drive hole;
a rotatable compression screw having a first end and a second end;
a compression plate having an upper end and a lower end, wherein the upper end comprises at least one cut slot;
whereby the second end of the rotatable compression screw passes through the threaded drive hole of the upper casing and into a threaded cavity of the upper end of the compression plate,
whereby the lower end of the compression plate is flat and is configured to engage with soap slabs placed in the open top chamber of the lower casing, wherein the soap slabs are soaked in hot water for a predetermined time to form a film over the surface of the soap slabs;
an “E”-Ring, wherein the at least one slot in the upper end of the compression plate is configured to allow the “E”-Ring to quick engage with the compression screw, thereby allowing the compression plate to move up and down while rotating the compression screw, and
a means for detachably retaining the upper and the lower casings together, while force is applied on the plurality of soap slabs in the lower casing through the lower end of the compression plate to compress the soaked soap slabs to weld with each other to form the soap bar.

2. The apparatus of claim 1, wherein the lower casing and the upper casing have a rectangular shape with rounded corners.

3. The apparatus of claim 1, wherein pressing the “E”-Ring on to the compression screw at the at least one slot creates a snug fit of the “E”-Ring with the compression screw allowing the compression screw to rotate without twisting the compression plate.

4. The apparatus of claim 1, wherein the soap slabs are soaked in hot water for a predetermined time of ranging from about 3 to about 5 minutes to form a film over surface of each of the soap slabs.

5. The apparatus of claim 1, wherein the lower casing and the upper casing are manufactured from material selected from the group consisting of polyurethane, polyethylene, polyvinyl chloride, a polymer and a metal or a combination thereof.

6. The apparatus of claim 1, wherein the upper end of the compression plate comprises a tubular profile that is configured to mate with the profile of the neck of the upper casing when the compression plate is moved upward.

7. The apparatus of claim 1, wherein a handle is attached to a first end of the compression screw to facilitate the rotation of the compression screw to move the compression plate up and down.

8. The apparatus of claim 1, wherein the means for detachably retaining the upper and the lower casings together is a pair of Velcro® straps.

9. An apparatus for forming a soap bar by compression welding a plurality of soap slabs, the apparatus comprising:
a lower casing having an open top chamber enclosed by one or more side walls and a bottom wall;
an upper casing having an open bottom chamber enclosed by one or more side walls and a top wall, wherein the open bottom chamber is configured to enclose the lower casing, the top wall further defined by a neck, the neck forming a concentric threaded drive hole;
a drive member, wherein the drive member comprises a rotatable compression screw having a first end and a second end and a compression plate having an upper end and a lower end,
whereby the upper end of the compression plate comprises a tubular profile that is configured to mate with the profile of the neck of the upper casing when the drive member is moved upward and further the upper end comprising at least one cut slot,
whereby a handle is attached to the first end of the compression screw and the second end of the compression screw passes through the threaded drive hole in the neck of the upper casing and into a threaded cavity of the upper end of the compression plate,
whereby, the lower end of the compression plate is flat and is configured to engage with the soap slabs placed in the open top chamber of the lower casing, wherein the soap slabs are soaked in hot water for a predetermined time to form a film over surface of each of the soap slabs;
an “E”-Ring, wherein the at least one slot in the upper end of the compression plate is configured to allow the “E”-Ring to engage with the compression screw, thereby allowing the compression plate to move up and down without twisting while rotating the handle of the compression screw; and
a plurality of straps detachably retaining the upper and the lower casings together in a stable, joined configuration while force is applied on the plurality of soap slabs in the lower casing through the lower end of the compression plate of the drive member to compress the soaked soap slabs to weld with each other into a single soap bar.

10. The apparatus of claim 9, wherein the lower casing and the upper casing have a rectangular shape with rounded corners.

11. The apparatus of claim 9, wherein the straps are fixedly fastened to the upper casing thereby facilitating quick detachable attachment of the lower casing to the upper casing.

12. The apparatus of claim 9, wherein the straps comprise a pair of Velcro® straps.

13. The apparatus of claim 9, wherein pressing the “E”-Ring on to the compression screw at the at least one slot creates a snug fit of the “E”-Ring with the compression screw.

14. The apparatus of claim 9, wherein the lower casing and the upper casing are manufactured from material selected from the group consisting of polyurethane, polyethylene, polyvinyl chloride, a polymer and a metal or a combination thereof.

15. The apparatus of claim 9, wherein the soap slabs are soaked in hot water for a predetermined time of about 3 to about 5 minutes to form a film over surface of each of the soap slabs.

16. A method for forming a soap bar from a plurality of soap slabs, the method comprising:
soaking the plurality of soap slabs in hot water for a predetermined time so as to form a film over surface of each of the soap slabs;
placing the plurality of soap slabs flat one over the other in a lower casing in a vertical stacked position;
coupling an upper casing to the lower casing;
passing a compression screw through a threaded drive hole of the upper casing, wherein a handle is attached to a first end of the compression screw;
fastening a compression plate to a second end of the compression screw through an “E”-Ring;
wrapping a plurality of straps around the upper and the lower casings;
rotating the handle to rotate the compression screw in a first direction to force the compression plate onto the vertically stacked soaked soap slabs to form a compression welded soap bar and then rotating the compression screw in a second direction to raise the compression plate from the formed soap bar without twisting the compression plate;
removing the straps from around the upper and the lower casings;
decoupling the upper casing from the lower casing;
drying the formed soap bar for at least one hour to form a dried soap bar; and
removing the dried soap bar from the lower casing.

17. The method of claim 16, wherein the “E”-Ring is fastened to the compression screw at an at least one cut slot in an upper end of the compression plate.

18. The method of claim 16, wherein the lower casing and the upper casing are manufactured from a material selected from the group consisting of polyurethane, polyethylene, polyvinyl chloride, a polymer and a metal or a combination thereof.

19. The method of claim 16, wherein the plurality of soap slabs are placed flat one over the other in an open top chamber of the lower casing in a vertical stacked position.

20. The method of claim 16, wherein the soap slabs are soaked in hot water for a predetermined time of about 3 to about 5 minutes to form a film over surface of each of the soap slabs.
